(19) United States
(12) Patent Application Publication
(10) Pub. No.: US 2004/0240585 A1
(43) Pub. Date: Dec. 2, 2004

(54) Time alignment of signals

(76) Inventors: John Bishop, Bath (GB); Antony James Smithson, North Yorkshire (GB); Richard Michael Bennett, Bristol (GB)

Correspondence Address: MENDELSOHN AND ASSOCIATES PC, 1515 MARKET STREET, SUITE 715, PHILADELPHIA, PA, 19102, US

(21) Appl. No.: 10/480,892

(22) PCT Filed: Jun. 12, 2002
(86) PCT No.: PCT/GB02/02659

(30) Foreign Application Priority Data
Jun. 15, 2001 (GB) 0114801.4

(51) Int. Cl. H04K 1/02

(52) U.S. Cl. 375/297

(57) ABSTRACT

Envelope-type signals are detected for the input and output of a linearised amplifier (12). The variance of the signal obtained from the output is measured and a variable delay (24) between the detected signals is adjusted to minimise the variance. The value of the variable delay then gives the propagation delays through the linearised amplifier. Further envelope-type signal from the output and interpolation can be used to enhance the adjustment of the delay to minimise variance.

The invention relates to signal processing methods and apparatus. In particular, the invention relates to apparatus for assessing delays between signals and bringing signals into time alignment.

It is known to use a lineariser to adjust the output signal of an amplifier to make it more linear, e.g. to remove the effects of intermodulation distortion occurring within the amplifier. Moreover, it is known to compare the input and output signals of the amplifier to measure residual distortion in the amplifier's output and to adjust the lineariser to eliminate the residual distortion. It has been determined that the time alignment of the monitored input and output signals affects the ability of the lineariser to adapt successfully to the presence of residual distortion.

According to one aspect, the invention provides signal processing apparatus comprising monitoring means for monitoring an input signal to and an output signal from signal handling equipment to produce an input assay signal related to the input signal's envelope and an output assay signal related to the output signal, capturing means for capturing values of the output assay signal for various input assay signal values and adjusting means for adjusting a variable delay between said monitored signals to reduce a variance in the captured values.

The invention also consists in a signal processing method comprising monitoring an input signal to and an output signal from signal handling equipment to produce an input assay signal related to the input signal's envelope and an output assay signal related to the output signal, capturing values of the output assay signal for various input assay signal values and adjusting a variable delay between said monitored signals to reduce a variance in the captured values.

When the variance is reduced zero, in the absence of variations in other parameters, a plurality of captured output assay signal values relating to the same input assay signal value will all be substantially the same. By reducing the variance, a time mis-alignment between the monitored signals (i.e. the monitored input and output signals) is reduced. This is advantageous where the assay signals are to be used for other, dependent signal processing operations (e.g. implementing adaptive control of a predistorter operating on the input signal) since a reduced time mis-alignment provides for greater accuracy in the dependent signal processing operations.

The assay signals may be sampled arbitrarily at any appropriate rate, without being limited to the Nyquist criterion. This permits the use of low cost-low performance processors for manipulating the assay signals. This freedom from the sampling bandwidth constraints that would otherwise be imposed is particularly important where the monitored input and output signals have a large bandwidth (e.g. where the input and output signals are wideband-CDMA signals). By using lower sampling rates, consumption of power and processing resources can be reduced in the signal processing hardware.

In one embodiment, the variable delay is adjusted to minimise the variance in the output assay signal values. When the variance is minimised, the monitored signals are substantially time aligned, which may result in the optimisation of the aforementioned dependent signal processing operations. The value of the variable delay at which this minimisation is achieved can be used to determine the propagation delay experienced by signals passing through the signal handling equipment. If the signal handling equipment itself includes an adjustable calibration delay, the total propagation delay through the signal handling equipment can be adjusted to an arbitrary value. Thus the propagation delays through each of a group of examples of the signal handling equipment can be equalised. This means that the signal handling equipment can be produced with a relaxation in the manufacturing tolerances that dictate the intrinsic propagation delay and yet achieve a desired standardisation of the propagation delay. Clearly a relaxation of such tolerances reduces the production cost and time-to-market of the signal handling equipment.

In a preferred embodiment, the variance of the captured output assay samples is measured for at least one sub-range or bin of the input assay signal. In one embodiment, several bins are used and together they cover substantially the entire range of the input assay signal. In another embodiment, the bins are selected to exclude certain regions of the input assay signal range (e.g. regions known to be unsuitable for variance measurements). Preferably, a mean output assay signal value is calculated for each (or the) bin and the variance for the bin is a measure of the displacement of the output assay signal in the bin from the mean for that bin. The variance for the output assay signal as a whole is taken to be the sum of the variances of each bin (where several bins are used).

In another embodiment, the variance is measured in a different manner. The output assay signal samples are plotted against their corresponding input assay signal samples and a curve (which could be a straight line) is fitted to at least some of the resulting points. One of a number of standard tests could be used to determine how well the curve fits the points and the assessment of the fit can be regarded as an assessment of the variance of the output assay signal samples.

However the variance is assessed, the variable delay can be adjusted to seek a reduction in the variance. In one embodiment the variable delay can be altered in discrete steps only; the smallest possible adjustment being known as the unit delay of the variable delay and, accordingly, it is possible to adjust the variable delay to the nearest unit delay to the time-alignment position (where minimum variance occurs). It is possible to derive a second output assay signal related to the output signal and to subject this to variance measurements to yield a second value for the setting of the variable delay that minimises the variance. By identifying the time-alignment position to the nearest variable delay value, the time alignment position can be determined to an accuracy of ½ a unit delay.

It is possible to use interpolation to improve further the accuracy of the determination of the time-alignment position. The values of the variance (or of a parameter derived therefrom) of an output assay signal for each of a plurality of values of the variable delay can be plotted and at least one curve can be fitted to the data points and an accurate determination of the time alignment position can be interpreted from the curve(s). A digital filter can be used to apply to the monitored signals a relative delay shift so that the monitored signals attain the time-alignment position calculated by interpolation.

In a preferred embodiment, the input assay signal is the square of the envelope of the input signal. In a preferred embodiment, the output assay signal is related to both the monitored input and output signals (where two output assay signals are used, they are preferably each related to both the input and output signals, but obviously via different relationships).

In one embodiment, the output assay signal is produced through the difference of two products of component vectors of the monitored signals. For example, where the monitored signals are in IQ format, the products may be the product of the in-phase component of the input signal with the quadrature-phase component of the output signal and the product of the quadrature-phase component of the input signal with the in-phase component of the output signal. Alternatively, the output assay signal may be the sum of two products of vector components of the monitored signals. For example, when the monitored signals are in IQ format, the products may be the product of the in-phase components of the input and output signals and the product of the quadrature-phase components of the input and output signals. Where two output assay signals are used, one may be produced through said sum of products and the other through said difference of products. It should be noted that the products could be calculated using a different set of orthogonal axes for the vector components.

In a further embodiment, the output assay signal is the square of the envelope of the monitored output signal.

In the preferred application of the invention, the signal handling equipment is an amplifier (or amplifying arrangement). The assay signals may be used by distortion counteracting equipment such as a lineariser for removing distortion in the amplifier output.

By way of example only, the invention will now be described with reference to the accompanying figures, in which:

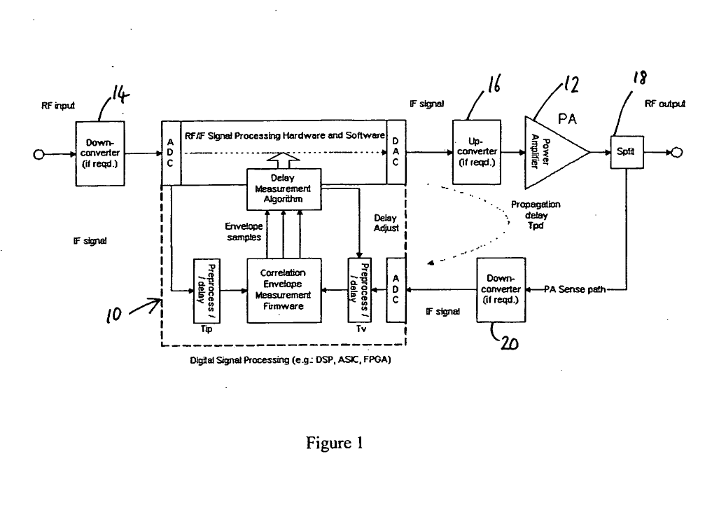

FIG. 1 is a block diagram of an amplifier linearisation scheme;

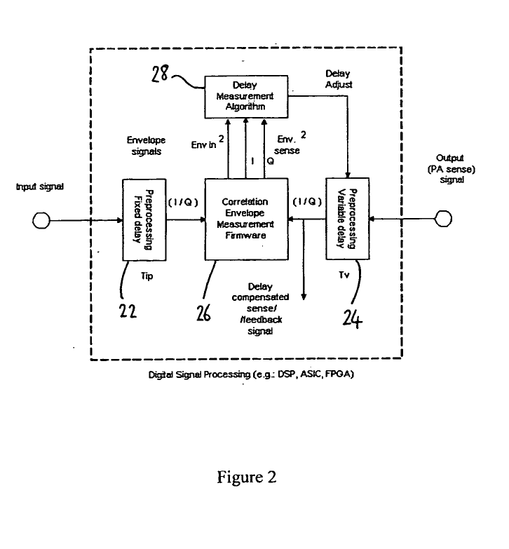

FIG. 2 is a block diagram illustrating how the DSP of FIG. 1 produces assay signals for the delay measurement and adjustment processes;

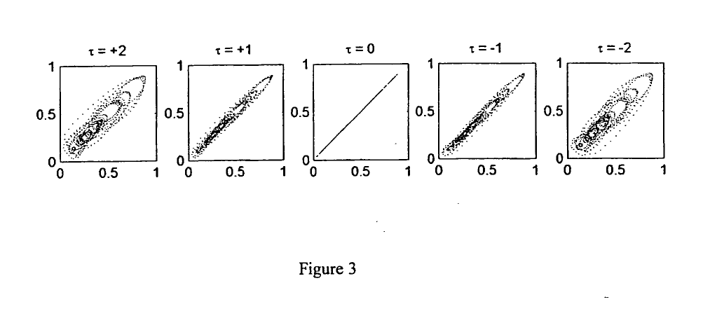

FIG. 3 illustrates some plots demonstrating how the variance changes with delay;

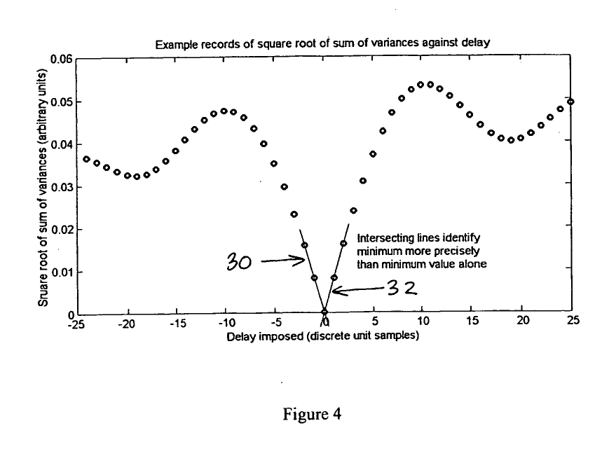

FIG. 4 is a plot of square root of variance against delay;

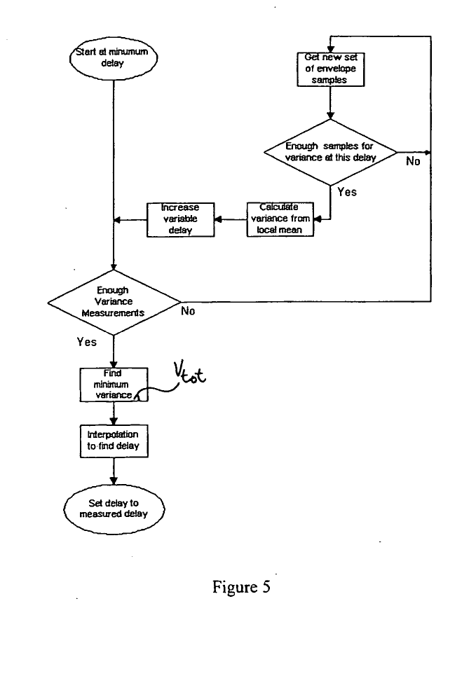

FIG. 5 is a flow chart illustrating a delay measurement algorithm; and

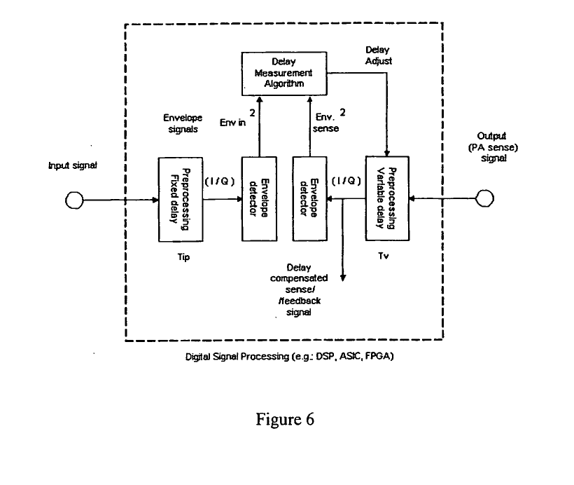

FIG. 6 is a block diagram illustrating how the DSP of FIG. 1 can produce different assay signals for the delay measurement and adjustment processes.

FIG. 1 illustrates a DSP (digital signal processor) 10 being used to linearise a radio frequency power amplifier RFPA 12. The DSP 10 acts as a predistorter to adjust the input signal to the amplifier 12 to ameliorate or eliminate distortion in the latter's output. If the centre frequencies taken by the amplifier input signal are incompatible with the sampling rate used by the DSP 10 then a frequency downconverter 14 can be used on the amplifier input signal supplied to the DSP and a frequency upconverter 16 can be used on the amplifier input signal issuing from the DSP. The output signal of the amplifier is sensed at splitter 18 and is supplied as a feedback signal to the DSP 10. If the band centre frequency of the sensed output signal is incompatible with the sampling rate of the DSP then frequency downconverter 20 can be used on the sensed output signal.

The DSP 10 uses the sensed output signal to, inter alia, measure the time it takes for the amplifier input signal to travel from the DSP, through the amplifier 16 and back to the DSP 10 as the sensed amplifier output signal. This period is known as the propagation delay and is mainly due to the amplifier although it is also due in part to other analogue domain delays, e.g. analogue delays caused by upconverter 16 and downconverter 20.

FIG. 2 illustrates the processes implemented by the DSP 10 that are concerned with measuring the propagation delay. Preprocessor 22 subjects the amplifier input signal to a fixed delay Tᵢₚ and converts it into IQ format. Preprocessor 24 subjects the sensed amplifier output signal to a variable delay Tᵥ and converts it into IQ format. The outputs of the preprocessors 22 and 24 are used by correlator 26 to produce three assay signals, namely (i) the square of the envelope of the amplifier input signal, (ii) the sum of the product of the I components of sensed input and output signals and the product of the Q components of the sensed input and output signals, and (iii) the product of the I component of the sensed input signal with the Q component of the sensed output signal, less the product of the Q component of the sensed input signal with the I component of the sensed output signal. Hereinafter, these signals shall be referred to as Eᵢₙₚᵤₜ, Eᵢₛₑₙₛₑ and E_{qsense} respectively.

The three assay signals are supplied to delay assessor 28 which uses the assay signals to determine whether the amplifier input signal issuing from preprocessor 22 (and subject to delay Tᵢₚ) is time-aligned with the sensed amplifier output signal issuing from preprocessor 24 (and subject to delay Tᵥ). The assessor adjusts the variable delay Tᵥ until the outputs of the preprocessors 22 and 24 are brought into time alignment. The value of the propagation delay T_{pd} can then be calculated from the known values of Tᵢₚ and Tᵥ since T_{pd}=Tᵢₚ−Tᵥ when the inputs to the correlator 26 are time aligned. The value of Tᵢₚ is set to permit the relative delay between the amplifier input signal and the sensed output signal to assume both positive to negative values as the variable delay is adjusted. To achieve this, Tᵢₚ is set to

$${T}_{ip} = {T}_{pd} ( est ) + \frac{1}{2} ( {T}_{v} ( max ) + {T}_{v} ( min ) ) ,$$

where T_{pd} (est) is an estimate of the propagation delay, and Tᵥ (max) and Tᵥ (min) are the maximum and minimum values respectively of Tᵥ.

By bringing the inputs to correlator 26 into time-alignment, the propagation delay is indirectly measured. If an adjustable delay is incorporated in the main signal path (through the amplifier), with knowledge of T_{pd} the propagation delay can be made up to any arbitrary value. This allows the standardisation of the propagation delays amongst a group of linearised amplifiers without recourse to stringent manufacturing tolerances for components associated with the propagation delay, thus reducing manufacturing costs and the time to bring the linearised amplifiers to market. The inputs to the correlator are used to detect residual distortion in the amplifier output and to adjust the linearisation process to minimise the residual distortion, and another benefit of time-aligning the correlator inputs is that the suppression of the residual distortion is improved.

As mentioned above, delay assessor 28 assesses, at each of a number of values of the adjustable delay Tᵥ, whether the correlator inputs are time-aligned. To assess the time alignment of the correlator inputs, assessor 28 performs a variance measurement on each of the signals Eᵢₛₑₙₛₑ and E_{qsense}. It is possible to assess the time-alignment by performing the variance measurement on only one of these assay signals although it is preferred to use both since this allows greater accuracy in the determination of the time-alignment and T_{pd}. The assay signals are not subject to the Nyquist sampling criterion for the bandwidth of the amplifier input and output signals and therefore the assessor can sample the assay signals Eᵢₙₚᵤₜ, Eᵢₛₑₙₛₑ and E_{qsense} at arbitrary times or at an arbitrary rate. Each time the assessor 28 samples the assay signals, it obtains three values, one for each assay signal. At each setting of the variable delay, the assessor takes a sufficient number of sample trios and performs variance measurements on Eᵢₛₑₙₛₑ and E_{qsense} at that value of Tᵥ. The value of Tᵥ is then adjusted, new sample trios are acquired and variance measurements are performed on Eᵢₛₑₙₛₑ and E_{qsense} at the new value of Tᵥ. This process continues until variance measurements have been made at a sufficient number of values of Tᵥ. The value of Tᵥ exhibiting the minimum variance is then determined to be the value of Tᵥ which brings the correlator inputs into time alignment and is the value of Tᵥ that is used to calculate T_{pd}.

The method of performing a variance measurement on envelope signal Eᵢₛₑₙₛₑ at a given value of Tᵥ will now be discussed. It will be understood that variance measurements are performed on E_{qsense} by an analogous process. The acquired Eᵢₙₚᵤₜ and Eᵢₛₑₙₛₑ sample pairs are tabulated and a mean Eᵢₛₑₙₛₑ value is calculated for each of a plurality of ranges of Eᵢₙₚᵤₜ which effectively divides Eᵢₙₚᵤₜ into a series of bins. The variance of Eᵢₛₑₙₛₑ is then calculated for each bin or range by reference to the bin's mean value of Eᵢₛₑₙₛₑ using, e.g., the equation:

$${V}_{m} = \frac{1}{N} {\sum }_{n = 1}^{N} {( {\overline{e}}_{m} - {e}_{n} )}^{2}$$

where Vₘ is the variance for the m^{th} bin, \overline{e}ₘ is the mean of Eᵢₛₑₙₛₑ for the m^{th} bin and eₙ represents the values of Eᵢₛₑₙₛₑ within the m^{th} bin and N is the number of Eᵢₛₑₙₛₑ values in the m^{th} bin.

The variance measurement Vₜₒₜ for the current value of Tᵥ is then given by

$${V}_{tot} = {\sum }_{m} {V}_{m} .$$

By summing local variances Vₘ, Vₜₒₜ is less affected by non-linearities in the amplifiers transfer characteristic (e.g. the amplifier's gain may diminish as the input signal level increases). Moreover, the bins included in the variance measurement can be restricted to those bins that are known to pertain to the most linear portions of the amplifier's transfer characteristic.

The graphs in FIG. 3 each plot sample pairs of Eᵢₙₚᵤₜ (abscissa) against Eᵢₛₑₙₛₑ (ordinate). Each graph is for a different value of the relative delay τ between the correlator inputs. As shown, when τ is zero, the variance in the Eᵢₛₑₙₛₑ values is a minimum.

FIG. 4 shows a plot of \sqrt{Vₜₒₜ} (ordinate) against τ (abscissa), where τ is determined by Tᵥ. Clearly the lowest plotted value of \sqrt{Vₜₒₜ} indicates the value of Tᵥ at which τ is minimised, but only to the accuracy of the step size in Tᵥ. The adjustable delay Tᵥ is implemented by an adjustable delay line in preprocessor 24 and the smallest step size possible is 1 sample period of the correlator input signals. In some circumstances, it is desirable to time-align the correlator inputs to better than 1 sample period and this can be achieved by interpolation, as will now be described.

Two straight lines are fitted to the\sqrt{Vₜₒₜ} data of FIG. 4. One straight line 30 is fitted to some sample points lying to the left of, and adjacent to, the minimum plotted value of \sqrt{Vₜₒₜ}. The other straight line 32 is fitted to some sample points lying to the right of, and adjacent to, the minimum plotted value of \sqrt{Vₜₒₜ}. The intersection of the straight lines indicates the time-alignment position to better than ±½ a sample period. The difference between the intersection and the minimum plotted \sqrt{Vₜₒₜ} value on the abscissa is the “fractional sample” delay. The correlator input signals can be aligned to eliminate the fractional sample delay by using a FIR filter in the preprocessor 24 to shift the sensed amplifier output signal by an amount equal to the fractional sample delay.

The straight lines fitted to the \sqrt{Vₜₒₜ} data are each fitted to a number of consecutive \sqrt{Vₜₒₜ} points adjacent the minimum plotted value of \sqrt{Vₜₒₜ}. The \sqrt{Vₜₒₜ} measurements around the minimum will lie on approximately straight sections of the \sqrt{Vₜₒₜ} curve, but more distant \sqrt{Vₜₒₜ} measurements will not. The number of points that can be validly used to fit the straight lines is dependent on the bandwidth and sampling rate of the amplifier input and output signals. By way of general guidance this number is given approximately by:

$$\frac{1}{10 \cdot Δ v \cdot Δ τ}$$

where Δv is the 3 dB bandwidth in H_{z} and Δτ is the step size of the delay line in seconds.

The foregoing interpolation process uses \sqrt{Vₜₒₜ} because the portions of the \sqrt{Vₜₒₜ} plot adjacent the minimum are approximately linear. In another embodiment, the fractional sample delay is calculated by fitting a parabolic curve to a group of Vₜₒₜ values around the minimum (e.g. to the 3 lowest values of Vₜₒₜ). The fractional sample delay is then computed from the ordinate value of the parabolic curve's minimum.

The flow chart in FIG. 5 illustrates the process of determining the value of Tᵥ that time-aligns the inputs to the correlator.

FIG. 6 concerns another embodiment of the invention and illustrates the processes in the DSP 10 which are involved in time-aligning the versions of the amplifier input and output issued by the preprocessors. Here, the envelopes of the input and output signals are determined and these two envelope signals provide the assay signals which are used in the variance assessment used to calculate T_{pd} and the value of Tᵥ which brings the signals into the alignment.

It will be apparent to the skilled person that many modifications may be made to the described embodiments without exceeding the scope of the invention. For example, the role of the DSP could be performed equally well by an ASIC or a FPGA.

1-27. (canceled)

28. A method for processing signals in a signal processing apparatus adapted to generate an output signal from an input signal, the method comprising:
generating, over multiple sampling times, a plurality of samples of the input signal;
generating, over multiple sampling times, a plurality of samples of the output signal;
adjusting a variable delay in the signal processing apparatus to reduce a variance measure based on the input and output samples.

29. The invention of claim 28, wherein the signal processing apparatus comprises:
an amplifier adapted to generate the output signal; and
a predistorter adapted to pre-distort the input signal prior to amplification by the amplifier to linearize the output signal.

30. The invention of claim 28, further comprising determining a propagation delay through the signal processing apparatus based on the adjustment of the variable delay.

31. The invention of claim 30, further comprising adjusting the propagation delay through the signal processing apparatus.

32. The invention of claim 31, wherein the propagation delay through the signal processing apparatus is adjusted to synchronize operation of the signal processing apparatus with operation of one or more other signal processing apparatuses.

33. The invention of claim 28, wherein:
each input signal sample comprises an Iᵢₙ component and a Qᵢₙ component;
each output signal sample comprises an Iₒᵤₜ component and a Qₒᵤₜ component;
at each sampling time, one or more assay signals are generated from the components of the input and output signal samples; and
the variance measure is generated using at least one of the one or more assay signals.

34. The invention of claim 33, wherein:
the one or more assay signals comprise an assay signal Eᵢₛₑₙₛₑ based on a sum of (i) a product of the Iᵢₙ and Iₒᵤₜ components and (ii) a product of the Qᵢₙ and Qₒᵤₜ components;
a first variance measure is generated using the assay signal Eᵢₛₑₙₛₑ; and
the variable delay is adjusted based on the first variance measure.

35. The invention of claim 34, wherein:
the one or more assay signals further comprise an assay signal E_{qsense} based on a difference between (i) a product of the Iᵢₙ and Qₒᵤₜ components and (ii) a product of the Qᵢₙ and Iₒᵤₜ components;
a second variance measure is generated using the assay signal E_{qsense}; and
the variable delay is adjusted based on the first and second variance measures.

36. The invention of claim 33, wherein:
the one or more assay signals comprise an assay signal E_{qsense} based on a difference between (i) a product of the Iᵢₙ and Qₒᵤₜ components and (ii) a product of the Qᵢₙ and Iₒᵤₜ components;
a first variance measure is generated using the assay signal E_{qsense}; and
the variable delay is adjusted based on the first variance measure.

37. The invention of claim 28, wherein:
each input signal sample comprises an envelope measure for the input signal;
each output signal sample comprises an envelope measure for the output signal; and
the variance measure is generated using the input and output envelope measures.

38. The invention of claim 28, wherein:
the input and output signals are each sampled at a plurality of frequency sub-ranges;
a sub-range variance measure is generated for each of the frequency sub-ranges; and
the variance measure is based on the plurality of sub-range variance measures.

39. The invention of claim 38, wherein the plurality of frequency sub-ranges excludes one or more frequency sub-ranges within the full frequency range of the signal processing apparatus.

40. The invention of claim 39, wherein each excluded frequency sub-range corresponds to a frequency range over which the signal processing apparatus operates in a relatively non-linear manner as compared to the non-excluded frequency sub-ranges.

41. The invention of claim 28, wherein the variance measure is determined by applying a graph-based technique to one or more assay signals generated from the input and output signal samples.

42. The invention of claim 41, wherein the graph-based technique involves interpolation based on an intersection of two straight lines generated from the one or more assay signals.

43. The invention of claim 28, wherein the signal processing apparatus applies (i) the variable delay to one of either the input samples or the output samples and (ii) a fixed delay to the other of either the input samples or the output samples.

44. The invention of claim 43, wherein the signal processing apparatus applies (i) the variable delay to the output samples and (ii) the fixed delay to the input samples.

45. A signal processing apparatus adapted to generate an output signal from an input signal, the signal processing apparatus comprising:
means for generating, over multiple sampling times, a plurality of samples of the input signal;
means for generating, over multiple sampling times, a plurality of samples of the output signal;
means for adjusting a variable delay in the signal processing apparatus to reduce a variance measure based on the input and output samples.

46. A signal processing apparatus adapted to generate an output signal from an input signal, the signal processing apparatus comprising:
an input signal preprocessor adapted to delay samples of the input signal generated over multiple sampling times;
an output signal preprocessor adapted to delay samples of the output signal generated over multiple sampling times;
a correlator adapted to generate one or more assay signals from the input and output samples; and
a delay assessor adapted to adjust a variable delay in at least one of the input and output signal preprocessors to reduce a variance measure based on the one or more assay signals.

47. The invention of claim 46, further comprising
an amplifier adapted to generate the output signal; and
a predistorter adapted to pre-distort the input signal prior to amplification by the amplifier to linearize the output signal.

48. The invention of claim 46, wherein the delay assessor is further adapted to determine a propagation delay through the signal processing apparatus based on the adjustment of the variable delay.

49. The invention of claim 48, further comprising an adjustable calibration delay adapted to adjust the propagation delay through the signal processing apparatus.

50. The invention of claim 49, wherein the adjustable calibration delay is adapted to be adjusted to synchronize operation of the signal processing apparatus with operation of one or more other signal processing apparatuses.

51. The invention of claim 46, wherein:
each input signal sample comprises an Iᵢₙ component and a Qᵢₙ component;
each output signal sample comprises an Iₒᵤₜ component and a Qₒᵤₜ component;
at each sampling time, one or more assay signals are generated from the components of the input and output signal samples; and
the variance measure is generated using at least one of the one or more assay signals.

52. The invention of claim 46, wherein:
the input and output signals are each sampled at a plurality of frequency sub-ranges;
a sub-range variance measure is generated for each of the frequency sub-ranges; and
the variance measure is based on the plurality of sub-range variance measures.

53. The invention of claim 46, wherein:
the output signal preprocessor applies the variable delay to the output signal samples; and
the input signal preprocessor applies a fixed delay to the input signal samples.
